(19) United States
(12) Patent Application Publication
(10) Pub. No.: US 2016/0066590 A1
(43) Pub. Date: Mar. 10, 2016

(54) FERMENTED DAIRY PRODUCTS SUITABLE FOR FRUIT TASTE ENHANCEMENT

(71) Applicant: DANONE GMBH, Haar (DE)

(72) Inventors: Aurélie Guiot, St Johann in Tirol (AT); Robert Kunkel, Glonn (DE); Petra Lutz, Brannenburg (DE)

(21) Appl. No.: 14/786,382

(22) PCT Filed: Apr. 23, 2014
(86) PCT No.: PCT/EP2014/058279

§ 371 Date: Oct. 22, 2015

Related U.S. Application Data
(60) Provisional application No. 61/815,646, filed on Apr. 24, 2013.

(30) Foreign Application Priority Data
Apr. 24, 2013 (EP) 13165160.6

(51) Int. Cl. A23C 9/133; A23L 1/235; A23C 9/123

(52) U.S. Cl. CPC A23C 9/133; A23C 9/1238; A23L 1/235; A23V 2002/00; A23Y 2240/75; A23Y 2220/29

(57) ABSTRACT

The invention concerns fermented dairy products, such as yogurts, suitable for fruit taste enhancement, preferably in fruit containing fermented dairy products. The products comprise specific bacterial strains.

The invention concerns fermented dairy products, such as yogurts, suitable for fruit taste enhancement, preferably in fruit containing fermented dairy products. The products comprise some specific bacterial strains.

The food industry uses various bacteria, in the form in particular of ferments (also referred to as “starter cultures”), in particular lactic acid bacteria, in order to improve the taste and the texture of foods but also to extend the shelf life of these foods. In the case of the dairy industry, lactic acid bacteria are used intensively in order to bring about the acidification of milk (by fermentation) but also in order to texturize the product into which they are incorporated.

Among the lactic acid bacteria used in the food industry, one can mention the genera Streptococcus and Lactobacillus. The lactic acid bacteria Streptococcus thermophilus and Lactobacillus delbrueckii ssp bulgaricus are used in particular in the formulation of the ferments used for the production of fermented dairy products, typically fermented milks, for example yogurts.

Processes for manufacturing fruit yogurts typically comprise fermentation of an inoculated milk base composition, cooling down of the final coagulum, addition of a fruit preparation, filling and then storage at cold temperature. During the cold storage, the yogurt can see some of its functional and sensorial properties varying over the time.

The acidity produced in yogurt depends mainly on the acidifying activity of the culture (Streptococcus thermophilus and Lactobacillus delbrueckii ssp. bulgaricus) and therefore the amount of lactic acid produced during the fermentation, and also the residual acidity produced during cold storage. The texture can also vary during storage and participates in the final product sensorial properties.

The recipe can also have an impact on the yogurt sensorial properties, for example by modifying the texture or the aroma perception. For example, removing the fat content of yogurt modifies its properties. Thus, maintaining yogurt texture can be a problem. In the dairy industry, some polysaccharides are introduced to address this problem.

Some ferments including Streptococcus thermophilus and/or Lactobacillus delbrueckii ssp. bulgaricus bacterial strain(s) have been described as providing some fruity flavor notes upon fermenting milk. However the combination of these with fruits has not been described and the intensity of such flavors is believed to be much lower than the intensity provided by fruits addition.

In fruit-based products, a fruit preparation is added to a yogurt white mass to give a specific sensorial profile to the yogurt, especially a fruit taste profile. Further to fruits, such products usually include fruits flavors or fruit flavor enhancers to provide a marked fruit taste. On one hand, such flavors or flavor enhancers are not well perceived by some consumers appreciating more naturality. There is a need for products that present reduced or completely removed added flavors. There is also a need for simplified and/or less expensive recipes that allow a reduced amount or a complete removal of such flavors or flavor enhancers. There is also a need for products that allow having a further magnified fruit taste. Consequently, there is a need for a culture that provides an enhanced fruit flavor when used in a yogurt produced without added flavors. There is a need for products having an appreciated and/or flavor-intense enough taste that can compete with products having higher amounts of flavor additives.

The invention addresses at least one of the problems or needs above with a fermented dairy product comprising a white mass being the fermentation product of a milk-based composition and a starter culture,

wherein the starter culture comprises one or more bacterial strains selected from the group consisting of:

Strain A: Streptococcus thermophilus DS71579, deposited with the Centraalbureau voor Schimmelcultures (Uppsalalaan 8, 3584 CT Utrecht, Netherlands) on Apr. 9, 2013 under the deposition number CBS134831,

Strain B: Streptococcus thermophilus DS71586, deposited with the Centraalbureau voor Schimmelcultures on Apr. 9, 2013 under the deposition number CBS134834,

Strain C: Streptococcus thermophilus DS71584, deposited with the Centraalbureau voor Schimmelcultures on Apr. 9, 2013 under the deposition number CBS134832,

Strain D: Streptococcus thermophilus DS71585, deposited with the Centraalbureau voor Schimmelcultures on Apr. 9, 2013 under the deposition number CBS134833, and

Strain E: Lactobacillus delbrueckii ssp. bulgaricus DS71836 deposited with the Centraalbureau voor Schimmelcultures on Apr. 9, 2013 under the deposition number CBS134835.

The invention also concerns products that further comprise fruits. The invention also concerns a process of making the fermented dairy product, comprising the steps of:

a) providing a milk-based composition,
b) inoculating the starter culture,
c) allowing a fermentation,
d) recovering a white mass, and
e) adding a fruit preparation to the white mass.

The invention also concerns the use of the starter culture in fermented dairy products. The invention also concerns the use of the white mass to make products comprising fruits, preferably substantially free of flavor additive(s).

### DEFINITIONS

In the present application a flavor additive refers to a compound or composition of matter, different from a fruit, added to a product or an intermediate thereof to provide a flavor taste modification. Flavor additives encompass aromas and are known by the one skilled in the art. They are typically labeled on dairy fermented products. Flavors are for example listed on European regulation EU 872/2012. Examples of flavors include some acids, esters, ketones, terpens, alcohols, benzoic cycles, fatty acids. Examples of common flavors, typically used in strawberry flavoring are methyl-butyrate, 3-6 hexenol, furaneol, caproic acid and decalactone.

In the present application a product “substantially free of flavor additive” refers to a product that does not comprise significant amounts of flavor additive. The amount might depend on the very flavor additive considered. The amount by weight is typically of lower than 1%, preferably lower than 0.1%, preferably lower than 0.01%, preferably lower than 0.001%, preferably lower than 1 ppm, preferably lower than 0.1 ppm, preferably lower than 0.01 ppm, preferably none. By “substantially free of flavor additive” it is preferably meant that no flavor additive is added and/or that the presence of such compounds is not labeled.

### Product

The product of the invention is a fermented dairy product comprising a white mass and fruits. Such products are known by the one skilled in the art. It comprises the fermentation product of a milk-based composition and a starter culture, also referred to as “white mass”. The product can comprise components and/or ingredients further to the fermentation product, for example fruits, sweeteners, texture modifiers, conservation agents etc. . . . The product of the invention typically comprises, as part of the white mass the strains of the starter culture. Fruits can be present in the product for example in an amount of from 6% to 20% by weight. In a preferred embodiment the fruits are dispersed in the white mass.

In a particular embodiment the product is free of flavor additive(s).

Details about the starter culture, the white mass and further components and/or ingredients are given below.

### Starter Culture Description

The starter culture comprises one or more bacterial strains selected from the group consisting of:

Strain A: Streptococcus thermophilus DS71579,

Strain B: Streptococcus thermophilus DS71586,

Strain C: Streptococcus thermophilus DS71584,

Strain D: Streptococcus thermophilus DS71585, and

Strain E: Lactobacillus delbrueckii ssp. bulgaricus DS71836.

Herein strains A, B, C, D, and E refer to the strains as follows:
Strain A. Streptococcus thermophilus DS71579 deposited with the Centraalbureau voor Schimmelcultures on 9 Apr., 2013 under the deposition number CBS134831.
Strain B. Streptococcus thermophilus DS71586 deposited with the Centraalbureau voor Schimmelcultures on 9 Apr., 2013 under the deposition number CBS134834.
Strain C. Streptococcus thermophilus DS71584 deposited with the Centraalbureau voor Schimmelcultures on 9 Apr., 2013 under the deposition number CBS134832.
Strain D. Streptococcus thermophilus DS71585 deposited with the Centraalbureau voor Schimmelcultures on 9 Apr., 2013 under the deposition number CBS134833.
Strain E. Lactobacillus delbrueckii ssp. bulgaricus DS71836 deposited with the Centraalbureau voor Schimmelcultures on 9 Apr., 2013 under the deposition number CBS134835.
   The starter culture can be for example one of the compositions described below.
   Composition 1 comprising strain A
   Composition 2 comprising strain B
   Composition 3 comprising strain C
   Composition 4 comprising strain D
   Composition 5 comprising strain E

Compositions comprising at least 2 strains from the group consisting of strain A, strain B, strain C and strain D and strain E.
Composition 6 comprising strain A and strain B
Composition 7 comprising strain A and strain C
Composition 8 comprising strain A and strain D
Composition 9 comprising strain A and strain E
Composition 10 comprising strain B and strain C
Composition 11 comprising strain B and strain D
Composition 12 comprising strain B and strain E
Composition 13 comprising strain C and strain D
Composition 14 comprising strain C and strain E
Composition 15 comprising strain D and strain E

Compositions comprising at least 3 strains from the group consisting of strain A, strain B, strain C and strain D and strain E.
Composition 16 comprising strain A and strain B and strain C
Composition 17 comprising strain A and strain B and strain D
Composition 18 comprising strain A and strain B and strain E
Composition 19 comprising strain A and strain C and strain D
Composition 20 comprising strain A and strain C and strain E
Composition 21 comprising strain A and strain D and strain E
Composition 22 comprising strain B and strain C and strain D
Composition 23 comprising strain B and strain C and strain E
Composition 24 comprising strain B and strain D and strain E
Composition 25 comprising strain C and strain D and Strain E

Compositions comprising at least 4 strains from the group consisting of strain A, strain B, strain C and strain D and strain E.
Composition 26 comprising strain A and strain B and strain C and strain D
Composition 27 comprising strain A and strain B and strain C and strain E
Composition 28 comprising strain B and strain C and strain D and strain E
Composition 29 comprising strain A and strain B and strain D and strain E
Composition 30 comprising strain A and strain C and strain D and strain E
   Compositions comprising at least 5 strains from the group consisting of strain A, strain B, strain C and strain D and strain E.
Composition 31 comprising strain A and strain B and strain C and strain D and Strain E

Each of the 31 compositions listed may encompass different embodiments depending on the amount of the strains present in the composition. The individual strains in the compositions may constitute any suitable percentage of the total cfu's (colony forming units) in the compositions. Preferably, the compositions of the invention comprise only any of the strains A, B, C, D and E. In those compositions, these strains constitute 100% of the cfu's.

The composition of the invention may however comprise further other bacterial strains. In those compositions, the total cfu's relates not only to the strains A, B, C, D and E present in the composition but also to the other bacterial strains present in the compositions of the invention.

Strain E in the compositions of the invention (Lactobacillus delbrueckii ssp. bulgaricus DS71836) comprising 2 or more strains of which at least one strain is strain E, constitutes between 0.1% and 10% of the total cfu's of the composition, preferably between 0.2% and 5%, more preferably between 0.5% and 2%, more preferably between 0.8 and 1.2%, most preferably 1%. Preferably, the Streptococcus thermophilus strains A, B, C and D constitute the remaining cfu's of the composition of the invention.

In the compositions comprising one Streptococcus thermophilus strain (A or B or C or D) and strain E (compositions 9, 12, 14 and 15), strain E is present as described above, i.e. between 0.1% and 10% of the total cfu's of the composition, preferably between 0.2% and 5%, more preferably between 0.5% and 2%, more preferably between 0.8 and 1.2%, most preferably 1%. In those compositions, the Streptococcus thermophilus strain constitutes the remaining cfu's whereby the total cfu's is 100%.

The strains in the compositions comprising two of the Streptococcus thermophilus strains A, B, C and D may constitute the individual Streptococcus thermophilus strains in any suitable percentage of the total Streptococcus thermophilus cfu's in the composition.

For instance, in composition 6, strain A may constitute 10% of the total Streptococcus thermophilus cfu's in the composition whereby strain B then constitutes 90%. An alternative embodiment of composition 6 may comprise 30% of strain A and 70% of strain B, all relative to the total Streptococcus thermophilus cfu's in the composition. A preferred embodiment of composition 6, comprises the Streptococcus thermophilus strains in equal amounts, i.e. both constitute 50% of the total Streptococcus thermophilus cfu's in the composition.

In the compositions comprising two of the Streptococcus thermophilus strains and strain E (compositions 18, 20, 21, 23, 24 and 25), strain E is present as described above, i.e. between 0.1% and 10% of the total cfu's of the composition, preferably between 0.2% and 5%, more preferably between 0.5% and 2%, more preferably between 0.8 and 1.2%, most preferably 1%. In those compositions, the Streptococcus thermophilus strains constitute the remaining cfu's whereby the total cfu's is 100%.

The strains in the compositions comprising three of the Streptococcus thermophilus strains A, B, C and D may constitute the individual Streptococcus thermophilus strains in any suitable percentage of the total Streptococcus thermophilus cfu's in the composition.

For instance, in composition 16, strain A may constitute 10% of the total Streptococcus thermophilus cfu's in the composition, strain B 30% and strain C 60%. An alternative embodiment of composition 6 may comprise 30% of strain A and 50% of strain B and 20% of strain C, all relative to the total Streptococcus thermophilus cfu's in the composition. A preferred embodiment of composition 16 comprises the Streptococcus thermophilus strains in equal amounts, i.e. both constitute ⅓ of the total Streptococcus thermophilus cfu's in the composition. The same may apply to any of the compositions.

In the compositions comprising three of the Streptococcus thermophilus strains and strain E (compositions 27, 28, 29, and 30), strain E is present as described above, i.e. between 0.1% and 10% of the total cfu's of the composition, preferably between 0.2% and 5%, more preferably between 0.5% and 2%, more preferably between 0.8 and 1.2%, most preferably 1%. In those compositions, the Streptococcus thermophilus strains constitute the remaining cfu's whereby the total cfu's is 100%.

The strains in the compositions comprising the four Streptococcus thermophilus strains (composition 26) may constitute the individual Streptococcus thermophilus strains in any suitable percentage of the total Streptococcus thermophilus cfu's in the composition. For instance, in composition 26, strain A may constitute 10% of the total Streptococcus thermophilus cfu's in the composition, strain B 30%, strain C 40% and strain D 20%. An alternative embodiment of composition 16 may comprise 30% of strain A and 50% of strain B and 10% of strain C and 10% of strain D, all relative to the total Streptococcus thermophilus cfu's in the composition. A preferred embodiment of composition 26 comprises the Streptococcus thermophilus strains in equal amounts, i.e. both constitute ¼ of the total Streptococcus thermophilus cfu's in the composition.

In the compositions comprising all four Streptococcus thermophilus strains and strain E (composition 31), strain E is present as described above, i.e. between 0.1% and 10% of the total cfu's of the composition, preferably between 0.2% and 5%, more preferably between 0.5% and 2%, more preferably between 0.8 and 1.2%, most preferably 1%. In those compositions, the Streptococcus thermophilus strains constitute the remaining cfu's whereby the total cfu's is 100%.

In a preferred embodiment of composition 31, strain E constitutes 1% of the total cfu's and the four Streptococcus thermophilus strains constitute 99% of the total cfu's. The individual Streptococcus thermophilus strains may constitute any suitable percentage of the total Streptococcus thermophilus cfu's in the composition. The most preferred embodiment of composition 31 comprises 1 part of strain E and 24.5 parts of strain A, 24.5 parts of B, 24.5 parts of C and 24.5 parts of D.

### White Mass

The white mass is a fermented composition, typically a fermented milk product, such as yogurt, kefir, cheese etc. . . . Fermented milk products are known by the one skilled in the art. Such products are made from a milk-based composition and have undergone a fermentation step. The fermentation is typically done by microorganisms comprising lactic acid bacteria and optionally yeasts, and leads to the production of fermentation products, for example lactic acid and/or other fermentation metabolites, and/or leads to the multiplication of the microorganisms. The designation “fermented milk” can depend on local legislation, but is typically given to a dairy product prepared from skimmed or full fat milk, or concentrated or powdered milk, having undergone a heat treatment at least equivalent to a pasteurization treatment, and inoculated with lactic acid producing microorganisms. The white mass and the product are preferably a yogurt.

In the present invention, the microorganisms comprise the strains of the starter culture. It is mentioned that further microorganisms, preferably further lactic acid bacteria, can be introduced. Examples of further lactic acid bacteria include further Lactobacilli (Lactobacillus acidophilus, Lb. casei, Lb. plantarum, Lb. reuteri, Lb. johnsonii), further Streptococci (Streptococcus thermophilus), Bifidobacteria (Bifidobacterium bifidum, B. longum, B. breve, B. animalis) and/or Lactococci (Lactococcus lactis).

The white mass can be a set product, wherein fermentation occurs in the packaging or a stirred or drink product, wherein fermentation occurs in a tank, and is then stirred to lower the viscosity prior to pack.

The white mass can be made by a process comprising the steps of:

Step a) providing a milk-based composition,

Step b) inoculating the starter culture,

Step c) allowing a fermentation, and

Step d) recovering a white mass.

Step a)—Milk-Based Composition

The product and/or the process involve providing a milk-based composition. Milk-based compositions useful in such products and/or processes are known by the one skilled in the art of fermented dairy products. Herein a milk-based composition encompasses milk or milk fractions, and compositions obtained by mixing several previously separated milk fractions. Some water or some additives can be added to said milk, milk fractions and mixtures. Herein, milk typically refers to animal milk, for example cow milk. Some alternative animal milks can be used, such as sheep milk or goat milk.

The milk-based composition can typically comprise ingredients selected from the group consisting of milk, half skimmed milk, skimmed milk, milk powder, skimmed milk powder, milk concentrate, skim milk concentrate, milk proteins, cream, buttermilk and mixtures thereof. Some water or additives can be mixed therewith. Examples of additives that can be added include sugar, sweeteners different from sugar, fibers, and texture modifiers.

The milk-based composition can typically have a fat content of from 0% to 5% by weight, for example of from 0% to 1% or from 1% to 2% or from 2% to 3% or from 3% to 4% or from 4% to 5%.

The milk-based composition can typically have a fat content of from 2% to 6% by weight, for example of from 2% to 3% or from 3% to 4% or from 4% to 5% or from 5% to 6%.

The ingredients of the milk-based composition and/or the amounts thereof can be selected thereto.

Step a) can comprise sub-steps such as heat-treatments, for example pasteurization or sterilization, and/or homogenization. Such steps are known be the one skilled in the art.

Step a) can be performed using conventional equipments such as mixing equipments, heat exchangers, and homogenizers.

In a particular embodiment step a) comprises the following steps:
step a1) mixing ingredients to provide the milk-based composition,
step a2) pasteurizing at a temperature of at least 90° C.,
step a3) homogenizing and cooling to a temperature of less than 50° C.

Step a) can comprise a homogenization step. This is preferably carried out at step a3). Such operations are well known by the one skilled in the art and can be performed with conventional equipments. The homogenization can be performed at a pressure of at least 25 bars. In a particular embodiment, the homogenization phase is performed at a pressure of at least 100 bars. It is mentioned that the homogenization can be performed in two steps: one at a pressure of 100-200 bars, one at a pressure of 25-50 bars.

Step a) can comprise a heat treatment, such as pasteurization, Ultra High Temperature treatment, or High Temperature treatment. This is preferably carried out at step a2). Such treatments are known by the one skilled in the art, and can be performed with conventional equipments. The heat treatment is typically operated at at least 90° C. Depending on the temperature the treatment time can last typically from 1 s to 20 minutes.

Step a) can comprise a step of placing the mixture to a fermentation temperature, typically comprised between 30° C. and 50° C., preferably of 35° C. to 45° C. This is typically done by cooling after a heat treatment. This can be done for example at step a3).

Step b)—Inoculation

Step b) involves inoculating the starter culture in the milk-based composition. Such an operation is known by the one skilled in the art. Inoculation can be typically performed at a rate of from 0.002% to 0.2% by weight, for example from 0.002% to 0.01% or from 0.01% to 0.05% or from 0.05% to 0.2%.

In a particular embodiment, further lactic acid bacteria are inoculated. Examples of further lactic acid bacteria that can be inoculated include probiotic bacteria. Probiotic bacteria are known by the one skilled in the art. Examples of probiotic bacteria include some Bifidobacteria and Lactobacilli, such as Bifidobacterium brevis, Bifidobacterium animalis, Bifidobacterium animalis lactis, Bifidobacterium infantis, Bifidobacterium longum, Lactobacillus helveticus, Lactobacillus casei, Lactobacillus casei paracasei, Lactobacillus acidophilus, Lactobacillus rhamnosus, Lactobacillus plantarum, Lactobacillus reuteri, Lactobacillus delbrueckii subsp lactis, Lactobacillus delbrueckii subsp delbrueckii, Lactobacillus brevis and Lactobacillus fermentum.

Step c)—Fermentation

Step c) involves allowing a lactic fermentation. This is typically done at a temperature of higher than 30° C. This step is also referred to as a fermentation step. Step c) leads to a composition referred to as white mass.

Fermentation operations are known by the one skilled in the art. Fermentation can be typically performed at a temperature between 30° C. and 50° C., preferably from 35° C. to 45° C. Fermentation can be stopped by cooling and/or breaking the mixture when a breaking pH is reached. The fermentation time is the time between the inoculation and the breaking and/or cooling. The fermentation time can depend on the lactic acid bacteria, on the amount thereof, and on the temperature, and can for example last from 3 hours to 30 hours, for example from 12 to 22 hours.

During fermentation, the pH of the mixture decreases with production of lactic acid by the bacteria. The pH at the end of the fermentation can be typically of 5 or less than 5, preferably of from 3.5 to 4.6. In a preferred embodiment the fermentation is carried out to a pH of from 3.5 to 5 preferably from 4.5 to 4.9.

After fermentation, step c) can comprise a further step of stirring to obtain a composition having a desired viscosity. Such a step can be performed for example with a smoothing valve, for example at a pressure of at least 1.5 bars, or with a static mixer or with a dynamic mixer. This step provides some shear to composition that typically allow a viscosity drop and/or a reduction of grains. Such operations are known by the one skilled in the art, and can be operated with conventional appropriate equipments. This step is typically performed at cold temperature, for example at a temperature of from 1° C. to 25° C. It is mentioned that this stirring step is not performed in the case of set products, wherein fermentation is performed in packaging.

Step d)—Recovering White Mass

In step d) the white mass is recovered. In the case of set products the white mass is recovered directly in the packaging. In the case of stirred or drink products, the white mass is transferred to packing equipment, optionally with mixing and/or association with further ingredients and/or components such as fruits, sugar, sweeteners different from sugar, coloring agents, fibers, minerals, vitamins, fat or fat substitutes, for example vegetal fat, preservatives, etc.

### Fruits and Fruit Preparations

The product of the invention comprises fruits. Herein, fruits refer to any fruit form, including for example full fruits, pieces, purees, concentrates, juices etc.

The fruits can be typically introduced in the product by mixing the white mass with fruits, typically in the form of a fruit preparation, typically at step e). Such introductions and preparations are known by the one skilled in the art. Typically, a fruit preparation can be added in an amount of 5-35% by weight with reference to the total amount of product. In a particular embodiment the fruit preparation is substantially free of flavor additive(s).

The fruit preparation typically comprises a stabilizing system, having at least one stabilizer. The stabilizing system can comprise at least two stabilizers. Such stabilizers are known by the one skilled in the art. They typically help in avoiding phase separation of solids, for examples of fruits or fruits extracts and/or in avoiding syneresis. They typically provide some viscosity to the composition, for example a viscosity (Bostwick viscosity at 20° C.) of from 1 to 20 cm/min, preferably of from 4 to 12 cm/min.

The stabilizing system or the stabilizer can for example be a starch, a pectin, a guar, a xanthan, a carrageenan, a locust bean gum, or a mixture thereof. The amount of stabilizing system is typically of from 0.5% to 5% by weight.

The fruit preparation can typically comprise organoleptic modifiers. Such ingredients are known by the one skilled in the art.

The organoleptic modifiers can be for example sugars, sweetening agents different from sugar, coloring agents, cereals and/or cereal extracts.

Examples of sweetening agents are ingredients referred to as High Intensity Sweeteners, such as sucralose, acesulfamK, aspartam, saccharine, rebaudioside A or other steviosides or stevia extracts.

Examples of fruits include for example strawberry, peach, apricot, mango, apple, pear, raspberry, blueberry, passion, cherry, and mixtures or associations thereof, such as peach-passion.

The fruits can be for example provided as:

frozen fruit cubes, for example 10 mm fruit cubes, for example Individual Quick Frozen fruit cubes, for example strawberry, peach, apricot, mango, apple, pear fruit cubes or mixtures thereof,

Aseptic fruit cubes, for example 10 mm fruit cubes, for example strawberry, peach, apricot, mango, apple or pear fruit cubes or mixtures thereof,

fruit purees, for example fruit purees concentrated from 2 to 5 times, preferably 3 times, for example aseptic fruit purees, for example strawberry, peach, apricot, mango, raspberry, blueberry or apple fruit purees or mixtures thereof,

single aseptic fruit purees, for example strawberry, raspberry, peach, apricot, blueberry or apple single aseptic fruit purees or mixture thereof,

frozen whole fruits, for example Individual Quick Frozen whole fruits, for example blueberry, raspberry or blackberry frozen whole fruits, or mixtures thereof,

mixtures thereof.

The ingredients and/or components of fruit preparation and the amounts thereof are typically such that the composition has a brix degree of from 1 to 65 brix, for example from 1 to 10 brix, or from 10 to 15 brix, or from 15 to 20 brix, or from 20 to 25 brix, or from 25 to 30 brix, or from 30 to 35 brix, or from 35 to 40 brix, or from 40 to 45 brix, or from 45 to 50 brix, or from 50 to 55 brix, or from 55 to 60 brix, or from 55 to 60 brix, or from 60 to 65 brix.

The fruit preparation can for example comprise fruit in an amount of from 30% to 80% by weight, for example from 50 to 70% by weight.

The fruit preparation can comprise water. It is mentioned that a part of the water can come from ingredients used to prepare the fruit preparation, for example from fruits or fruit extracts or from a phosphoric acid solution.

The fruit preparation can comprise pH modification agents such as citric acid.

It is mentioned that the fruit preparation can be present as a mixture with the white mass, or in layered or side by side form, for example in a fruit on bottom form. In a preferred embodiment, the product is a mixture of the white mass and the fruit preparation.

### Packaging

The product is typically conditioned by filling in a container, such as a cup or a bottle, and then sealing, to obtain a finish product. Sealing can be performed for example with a cap or with a lid. The container can be for example a container of 50 ml (or 50 g), to 1 L (or 1 kg), for example a container of 50 ml (or 50 g) to 80 ml (or 80 g), or 80 ml (or 80 g) to 100 ml (or 100 g), or 100 ml (or 100 g) to 125 ml (or 125 g), or 125 ml (or 125 g) to 150 ml (or 150 g), or 150 ml (or 150 g) to 200 ml (or 200 g), or 250 ml (or 250 g) to 300 ml (or 300 g), or 300 ml (or 300 g) to 500 ml (or 500 g), or 500 ml (or 500 g) to 750 ml (or 750 g (or 750 ml (or 750 g) to 1 L (or 1 kg).

The product can be stored, transported and/or distributed at a chilled temperature of 0° C. to 10° C., preferably of 4° C. to 10° C.

### Use of Product

The product is typically to be used as a food product. It is typically used by oral administration. One can typically eat or drink the composition by processing it from a container to the mouth, optionally using a spoon, a glass, or a straw. The container is preferably a cup.

Further details or advantages of the invention might appear in the following non limitative examples.

### EXAMPLES

One prepares fermented dairy products, with the starting material described below, using the procedure describes below.

Skim Milk powder 1: Nutrilac 7700, Arla
Skim Milk powder 2: Nutrilac 45-85, Arla
Culture 1: blend of 24.5 parts of each of strain A, B, C and D and 1 part of strain E, all based on cfu's.
Culture 2 (comparative): A commercially available culture comprising at least one Streptococcus thermophilus bacterial strain, and at least one Lactobacillus delbrueckii ssp. bulgaricus.
Culture 3 (comparative): A commercially available culture comprising at least one Streptococcus thermophilus bacterial strain, and at least one Lactobacillus delbrueckii ssp. bulgaricus.
Culture 4 (comparative): A commercially available culture comprising at least one Streptococcus thermophilus bacterial strain, and at least one Lactobacillus delbrueckii ssp. bulgaricus.
Fruit preparation: Strawberry IQF cubes (55.9%), Strawberry puree 3 fold concentrate (4.1%), Sucrose (12.0%), water (23.2%), starch (3%), Locus bean gum (0.5%), Beet root juice concentrate (1.3). pH adjusted to 3.4. Brix=21°. This fruit preparation is free of additional flavors.

### Example 1

### White Mass Preparations

A milk-based composition is prepared by mixing 79.79 parts of skim milk, 9.01 parts of cream, 2.44 parts of water, 1.40 parts of skim milk powder 1, 0.25 parts of skim milk powder 2, and 7.00 parts of sugar.

The milk-based composition has the following:
Fat: 3.80%
Proteins: 4.30%

The milk-based composition is pre-heated to 75° C., then pasteurized at 95° C. for 6 minutes, then homogenized at 250 bars then 40 bars, then cooled to 40° C. 0.02 parts of the culture is inoculated, then a fermentation is allowed at 40° C. to a pH break of 4.7. The obtained mass is sheared with Ytron Z250 (tangential speed 3.87 m/s) then cooled to 20° C., to obtain a yogurt white mass.

Example

| | | Example 1.2 | Example 1.3 |
|---|---|---|---|
| | Example 1.1 | (comparative) | (comparative) |
| Culture used | Culture 1 | Culture 2 | Culture 3 |

### Example 2

### Yogurt with Strawberry

One mixes 80% of the white masses of example 1 with 20% of the fruit preparation. The product obtained is then packaged in a 100 g container and stored at 4° C.

The products are tasted after 15 days storage, by a panel of 3 trained people. Observations about taste are reported below:

Results are presented below

| | Example | | |
|---|---|---|---|
| | 2.1 | 2.2 (comparative) | 2.3 (comparative) |
| Culture in | Culture 1 | Culture 2 | Culture 3 |
| white mass | | | |
| White Mass | Example 1.1 | Example 1.2 (80%) | Example 1.3 |
| | (80%) | | (80%) |
| Fruit | 20% | 20% | 20% |
| preparation | | | |
| Comments | Sour, fruits tastes | Mild, flat taste, not | Very mild, |
| | supported and | fruity, | not fruity |
| | enhanced | | |

Yogurt of Example 2.1 is further tasted with comparison to a benchmark strawberry yogurt comprising flavors (Ehrmann Almighurt) is a mondic 120 people test, after 15 days storage. Both product are evaluated as having a similar overall acceptance, fruit taste intensity is evaluated as being just rights for both products.

### Example 3

### White Mass Preparations

A milk-based composition is prepared by mixing 70.63 parts of skim milk, 12.10 parts of cream, 10.25 parts of skim milk concentrate (36%) and 7.00 parts of sugar.

The milk-based composition has the following:
Fat: 3.68%
Proteins: 4.3%

The milk-based composition is pre-heated to 75° C., then pasteurized at 95° C. for 6 minutes, then homogenized at 250 bars then 40 bars, then cooled to 40° C. 0.02 parts of the culture is inoculated, then a fermentation is allowed at 40° C. to a pH break of 4.7. The obtained mass is sheared with Ytron Z250 (tangential speed 3.87 m/s) then cooled to 20° C., to obtain a yogurt white mass.

Example

| | | Example 3.2 | Example 3.4 |
|---|---|---|---|
| | Example 3.1 | (comparative) | (comparative) |
| Culture used | Culture 1 | Culture 2 | Culture 4 |

### Example 4

### Yogurt with Strawberry

One mixes 80% of the white masses of example 2 with 20% of the fruit preparation. The product obtained is then packaged in a 100 g container and stored at 4° C.

The products are tasted after 15 days storage, by a panel of 3 trained people. The following features are evaluated and reported below:
Overall acceptance score between 0 and 10 (10 being the best score),
Fruit intensity score between 0 and 5 (5 being the best score)
comments

| | Example | | |
|---|---|---|---|
| | | 4.2 | |
| | 4.1 | (comparative) | 4.4 (comparative) |
| Culture in white | Culture 1 | Culture 2 | Culture 4 |
| mass | | | |
| White Mass | Example 3.1 | Example 3.2 | Example 3.4 (80%) |
| | (80%) | (80%) | |
| Fruit preparation | 20% | 20% | 20% |
| Overall acceptance | 7.3 | / | 6.2 |
| Fruit intensity | 2.9 | | 2.6 |
| Comments | Fruity, fresh | Flat, not fruits | Cheesy, Less fruity |
| | jammy | | |

### Example 5

### Yogurt with Strawberry and Sensory Profiles

One mixes 78% of the white masses of example 2 with 22% of a fruit preparation identical to the fruit preparation used in previous examples, except that it is slightly more concentrated (concentration factor of 1.1).

The product obtained is then packaged in a 100 g container and stored at 4° C.

| | Example | | |
|---|---|---|---|
| | 5.1 | 5.4 (comparative) | 5.5 (comparative) |
| Culture in white | Culture 1 | Culture 4 | Benchmark |
| mass | | | strawberry yogurt |
| White Mass | Example | Example 3.4 (78%) | comprising flavors |
| | 3.1 (78%) | | (Ehrmann |
| Fruit | 22% | 22% | Almighurt) |
| preparation | | | |

The products of Examples 5.1, 5.4 (comparative) and 5.5 (comparative) are evaluated by a panel 12 expert judges, especially trained in evaluating spoonable plain or strawberry yogurts, according to a pure monadic, 2 repetition mode.

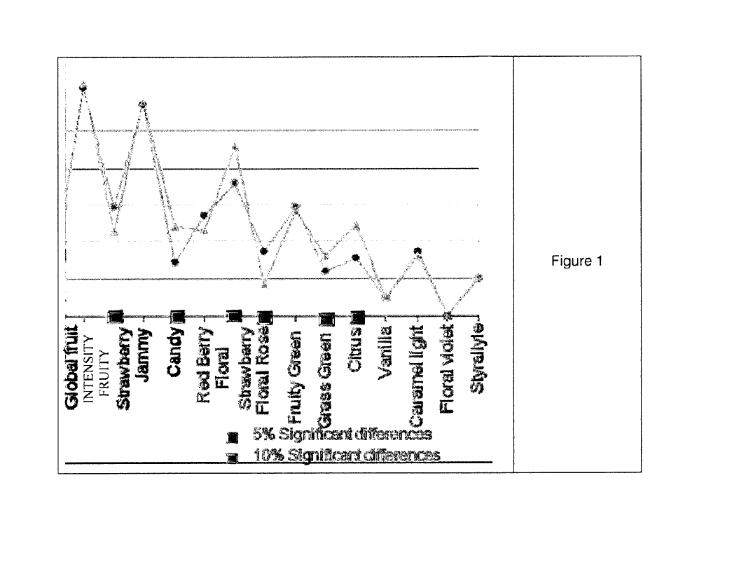

The strawberry aroma sensory profiles for Example 5.1 and 5.4 (comparative) are represented on FIG. 1, where the ordinates represents the average marking (from 1 to 7), and where circle correspond to comparative example 5.4 and triangles correspond to Example 5.1.

The results are further outlined below for Example 5.1 and comparative example 5.4:
Global fruit: 5.1 equivalent to 5.4 (comparative)
Fruit intensity: 5.1 slightly lower than 5.4 (comparative)
Strawberry Jammy: 5.1 equivalent to 5.4 (comparative)
Candy 5.1 higher than 5.4 (comparative)
Red Berry 5.1 equivalent to 5.4 (comparative)
Floral Strawberry 5.1 higher than 5.4 (comparative)
Floral Rose 5.1 lower than 5.4 (comparative)
Grass Green 5.1 higher than 5.4 (comparative)
Citrus 5.1 higher than 5.4 (comparative)
Vanilla 5.1 equivalent to 5.4 (comparative)
Caramel light 5.1 equivalent to 5.4 (comparative)
Floral violet 5.1 equivalent to 5.4 (comparative)
Styrralyle 5.1 equivalent to 5.4 (comparative)

The results are further outlined below for Example 5.1 and comparative example 5.5:
Global fruit: 5.1 equivalent to 5.5 (comparative)
Fruit intensity: 5.1 higher than 5.5 (comparative)
Strawberry Jammy: 5.1 higher than 5.5 (comparative)
Candy 5.1 higher than 5.5 (comparative)
Red Berry 5.1 equivalent to 5.5 (comparative)
Floral Strawberry 5.1 equivalent to 5.5 (comparative)
Floral Rose 5.1 equivalent to 5.5 (comparative)
Grass Green 5.1 equivalent to 5.5 (comparative)
Citrus 5.1 higher than 5.5 (comparative)
Vanilla 5.1 lower than 5.5 (comparative)
Caramel light 5.1 equivalent to 5.5 (comparative)
Styrralyle 5.1 lower than 5.5 (comparative)

1. A fermented dairy product comprising a white mass and fruits, the white mass being the fermentation product of a milk-based composition and a starter culture,
wherein the starter culture comprises one or more bacterial strains selected from the group consisting of:
Strain A: Streptococcus thermophilus DS71579, deposited with the Centraalbureau voor Schimmelcultures on Apr. 9, 2013 under the deposition number CBS134831,
Strain B: Streptococcus thermophilus DS71586, deposited with the Centraalbureau voor Schimmelcultures on Apr. 9, 2013 having deposition number CBS134834,
Strain C: Streptococcus thermophilus DS71584, deposited with the Centraalbureau voor Schimmelcultures on Apr. 9, 2013 under the deposition number CBS134832,
Strain D: Streptococcus thermophilus DS71585, deposited with the Centraalbureau voor Schimmelcultures on Apr. 9, 2013 under the deposition number CBS134833, and
Strain E: Lactobacillus delbrueckii ssp. bulgaricus DS71836 deposited with the Centraalbureau voor Schimmelcultures on Apr. 9, 2013 under the deposition number CBS134835.

2. A product according to claim 1, wherein the starter culture comprises Strain E and one or more of strain A, B, C and D.

3. A product according to claim 1, wherein the starter culture comprises Strain A, Strain B, Strain C, Strain D, and Strain E.

4. A product according to claim 3, wherein Streptococcus thermophilus strains constitute each 24.5 parts of the total CFUs in the starter culture, and wherein Strain E constitute 1 part of the total CFUs in the starter culture.

5. A product according to claim 1, comprising the strains of the starter culture.

6. A product according to claim 1, being substantially free of flavor additive(s).

7. A process of making a fermented dairy product according to claim 1, comprising the steps of:
a) providing a milk-based composition,
b) inoculating the starter culture,
c) allowing a fermentation,
d) recovering a white mass, and
e) adding a fruit preparation to the white mass.

8. A process according to claim 7, wherein the fruit preparation is substantially free of flavor additive(s).

9. A process according to claim 7, wherein an amount of 5-35% by weight of fruit preparation is added, with reference to the total amount of product.
